(19) United States
(12) Patent Application Publication
(10) Pub. No.: US 2024/0083391 A1
(43) Pub. Date: Mar. 14, 2024

(54) Roof Module Comprising an Environment Sensor and a Sensor Cover

(71) Applicant: Webasto SE, Stockdorf (DE)

(72) Inventors: Michael HUELSEN, Stockdorf (DE); Alexander KILIAS, Stockdorf (DE)

(21) Appl. No.: 17/768,160

(22) PCT Filed: Oct. 20, 2020
(86) PCT No.: PCT/EP2020/079506

§ 371 Date: Apr. 11, 2022

(30) Foreign Application Priority Data
Oct. 21, 2019 (DE) 10 2019 128 392.2

(51) Int. Cl. B60S 1/56; B60R 11/04; B60S 1/08; B60S 1/52; B62D 25/06

(52) U.S. Cl. CPC B60S 1/56; B60R 11/04; B60S 1/0822; B60S 1/528; B62D 25/06

(57) ABSTRACT

A roof module of a motor vehicle, in particular a passenger car, the roof module may have a roof skin, which forms an outer visible surface of the roof module, at least one sensor module having an environment sensor to detect a vehicle environment in an autonomous or semi-autonomous driving mode of the motor vehicle, and a sensor cover forming a see-through area for the environment sensor. The roof module may have a detector for detecting foreign particles on the see-through area of the sensor cover.

The invention relates to a roof module of a motor vehicle, in particular a passenger car, the roof module comprising the features of the preamble of claim 1.

Roof modules which can form a vehicle roof of, in particular, a passenger car, said vehicle roof being configured to be placed on top of a vehicle body, which forms a vehicle body shell, as a separate structural unit, are known from practice. Roof modules of this kind can be configured as a fixed roof having a completely vehicle-fixed roof skin or can have a roof opening system which comprises a lid element by means of which a roof opening can be opened or closed at will.

Furthermore, it is known for sensor modules which enable autonomous or semi-autonomous driving of the vehicle in question using driver assistance systems to be disposed on a vehicle roof, which can also be a roof module. The sensor modules, which have environment sensors for monitoring and detecting the vehicle surroundings, are attached to the vehicle roof since the vehicle roof is typically the highest point of a vehicle, from which the vehicle surroundings are easily visible. A sensor cover or a sensor housing forming a see-through area for the environment sensor can be provided to protect the environment sensor. The see-through area is transparent to the radiation used by the environment sensor. Due to weather conditions, environmental conditions, or other factors, however, the see-through area may lose its transparency to the environmental sensor because of an accumulation of particles, which can also form a film or a layer. This can make the operation of the sensor module unreliable.

The object of the invention is to provide a roof module which is configured according to the kind mentioned above and which allows the usability of the sensor module for an autonomous or semi-autonomous operation of the vehicle in question to be monitored.

According to the invention, this object is attained by the roof module having the features of claim 1.

So according to the invention, a roof module is proposed in which a see-through area of a sensor cover is provided with a detector for accumulated foreign particles so that the see-through area can be monitored with regard to usability. By detecting foreign particles by means of the detector, conclusions as to a sufficient transparency of the see-through area to radiation used by the environment sensor and thus as to the functionality of the roof module comprising the environment sensor and the sensor module can be drawn. If dirt or other accumulations, such as snow, water and/or ice, are detected on the see-through area, these foreign particles have to be cleaned off the latter.

The roof module configured according to the invention is a vehicle roof, in particular in an integrated manner, in which the components required for autonomous or semi-autonomous driving of the vehicle in question are accommodated. So the invention provides a sensor roof or a roof sensor module (RSM) which enables both the autonomous or semi-autonomous driving of the vehicle in question and a monitoring of the functionality of the roof module by detecting any foreign particles on the see-through area of the sensor cover.

The roof module according to the invention can form a structural unit in which a plurality of functional elements are integrated and which can be connected to a vehicle body or a vehicle body shell as a whole in the manner of a module so as to form the vehicle roof.

The environment sensor of the sensor module of the roof module according to the invention can basically be configured in various ways and can in particular comprise a lidar sensor, a radar sensor, an optical sensor, such as a camera, and/or the like. Lidar sensors operate in a wavelength range of 905 nm or of about 1550 nm, for example. The material forming the see-through area in particular has to be transparent to the wavelength range used by the at least one environment sensor; i.e., it has to be selected as a function of the wavelength used by the environment sensor. The see-through area can in particular be made of plastic, such as polycarbonate, PMMA or the like, or glass.

The term foreign particles is to be interpreted in its broadest sense and comprises dirt, such as insects or other smaller or larger objects, but also in particular film-like or coating-like forms of accumulations which result from rain, snow, ice, mud, and/or the like and which can compromise the functionality of the environment sensor.

In a preferred embodiment of the roof module according to the invention, the detector comprises a vibration sensor. The vibration sensor can comprise a piezo element, a MEMS sensor, an acceleration sensor, an optical sensor, which can comprise a laser measuring head, for example, and/or the like in a known manner. The vibration sensor is used to determine the vibration behavior of the see-through area as a function of the adherence of foreign particles. The transparency of the see-through area to the radiation used by the sensor module can be deduced from a change in the vibration behavior.

In a specific embodiment of the roof module according to the invention, the detector further comprises a vibration generator which can excite oscillations in the see-through area. The vibration generator is formed by a piezo element, for example. In particular, it is also conceivable for the vibration generator to be formed by the vibration sensor itself.

In order to be able to assess a measuring signal of the detector, a preferred embodiment of the roof module according to the invention has an evaluation unit by means of which a signal of the vibration sensor can be evaluated. The evaluation unit may use other vehicle signals in addition to the sensor signals.

The evaluation unit can comprise means which classify detected foreign particles, i.e., which can identify the nature of the dirt or the accumulation, for example, whether the detected foreign particles are insects or other lumpy objects, rain, snow, mud, and/or the like.

In order to counteract a detected soiling of the see-through area of the sensor cover, a preferred embodiment of the roof module according to the invention has a cleaning mechanism for the see-through area which can be activated as a function of an output signal of the detector and/or the evaluation unit.

The cleaning mechanism, by means of which the see-through area can be freed from the foreign particles, can be configured in various ways. For example, the cleaning mechanism comprises a cleaning or fluid nozzle by means of which a cleaning fluid, such as water, can be applied to the see-through area. Alternatively, a cleaning or fluid nozzle by means of which pressurized air or another cleaning gas can be applied to the see-through area of the sensor cover can be provided. So the fluid can be a liquid or a gas. It is also conceivable for the cleaning mechanism to comprise a wiping assembly, such as a pivotable wiper with a wiping lip, or an oscillation generator which excites oscillations in the sensor cover by ultrasound or the like with the result that the foreign particles come off the see-through area. The oscillation generator can be the vibration generator which generates the oscillations for the vibration sensor.

The roof module according to the invention can be a purely fixed roof element or can have a roof opening which can be closed or opened at will by means of a lid element of a roof opening system. The roof opening system can comprise a spoiler roof, an externally running sunroof or a lifting and sliding roof.

In the roof module according to the invention, preferably multiple environment sensors are disposed below a roof skin, which forms a one-piece or multiple-piece cover assembly of the roof module and is fixed, i.e., immobile, in relation to a vehicle body when the roof module is in the installed position. The cover assembly can have a cover element which extends in the transverse roof direction and which forms an outer side or an outer visible surface of a front or rear header of the vehicle in question. The roof skin can also comprise only a single cover element which continuously extends across the entire outer surface of the roof module in the case of a roof module without a roof opening. Multiple environment sensors are disposed under the respective cover element, a see-through area, which can be provided with a detector of the kind described above and with a cleaning mechanism of the kind described above, being formed on the cover element for each environment sensor.

Additionally, the roof module can have a frame, which can form an interface between the roof module and a vehicle body and on which the sensor modules and the environment sensors are disposed. The roof frame is also at least largely covered by the roof skin.

The invention also relates to a motor vehicle which comprises a roof module of the kind described above.

Other advantages and advantageous configurations of the subject matter of the invention are apparent from the description, the drawing, and the claims.

An embodiment example of a motor vehicle comprising a roof module according to the invention is schematically illustrated in the drawing and will be explained in more detail in the following description.

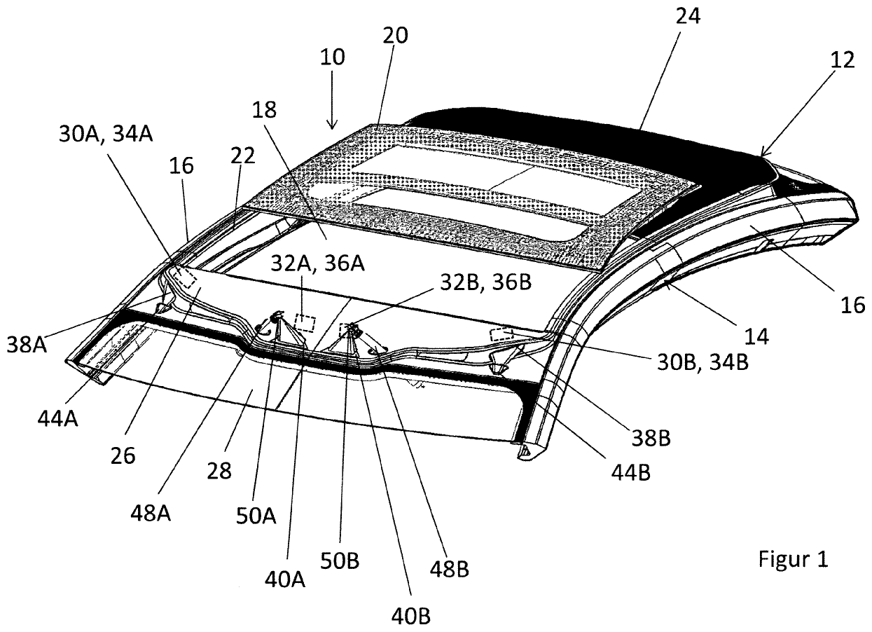

FIG. 1 is a perspective top view of a roof area of a motor vehicle comprising a roof module according to the invention; and

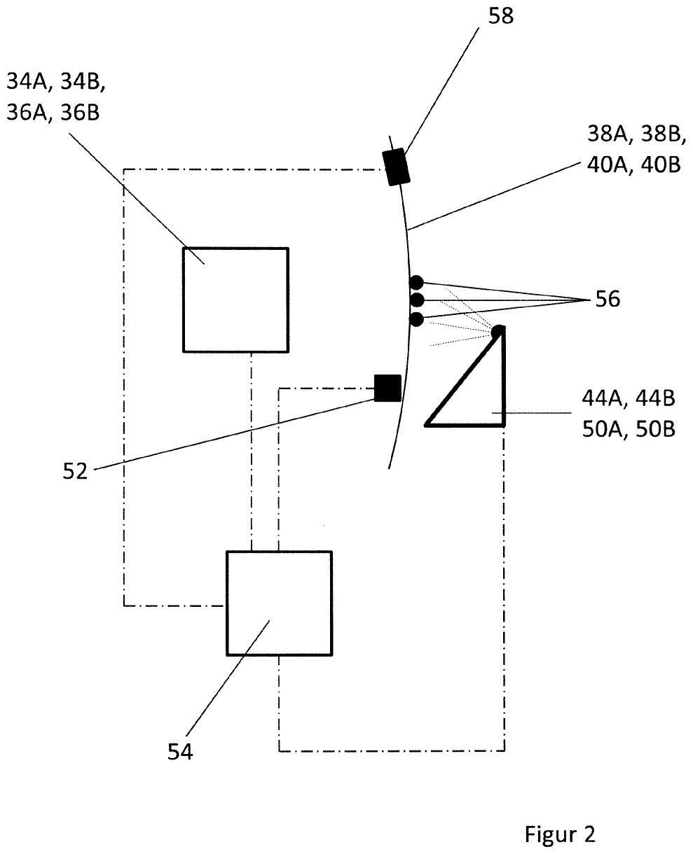

FIG. 2 is a cut through a portion of the roof module comprising an environment sensor in a highly schematized illustration.

FIG. 1 shows a vehicle roof 10 of a roof vehicle configured as a passenger car and having a roof module 12 placed on top of a vehicle body shell 14 which has, inter alia, a roof side beam 16 on either side of a vertical longitudinal center plane of the vehicle. Roof module 12 is a roof sensor module (RSM) which is equipped with devices allowing the motor vehicle to drive autonomously. As shown in FIG. 1, roof module 12 comprises a roof opening 18, which can be opened or closed at will by means of a lid element 20, which can be displaced in the longitudinal vehicle direction. To this end, lid element 20 is mounted on a guide rail on either side, each guide rail being part of a roof frame 22, which is a support structure of roof module 12. To the rear of roof opening 18, roof module 12 comprises a roof skin portion 24, which forms a fixed roof element. In the case of a roof module without a roof opening, a cover element can form the entire roof skin.

Forward of roof opening 18, roof module 12 comprises a roof skin portion 26, which is a roof cover extending across the width of the roof and associated with a front header of the motor vehicle, the front header extending in the transverse roof direction and comprising an upper transverse leg of a frame of a windshield 28. Multiple sensor modules 30A, 30B, 32A and 32B, which comprise environment sensors 34A, 34B, 36A and 36B, respectively, are disposed below roof skin portion 26, which forms a sensor cover. Environment sensors 34A and 34B each are what is referred to as a lidar sensor, which works with electrical radiation of a wavelength of 905 nm and/or 1550 nm. The two environment sensors 36A and 36B each comprise a camera, which can be a mono/multi/multifocal and/or stereo camera. The cameras of environment sensors 36A and 36B operate in the visible wavelength range and/or in the near infrared range. In the area of each of sensor modules 30A, 30B, 32A and 32B, roof skin portion 26, which forms a sensor cover, forms see-through areas 38A, 38B, 40A and 40B, respectively, which are transparent to wavelengths between 300 nm and 2000 nm and in particular also to radar radiation.

Forward of see-through areas 38A and 38B, roof module 12 has fluid nozzles 44A and 44B, respectively, by means of which respective see-through areas 38A and 38B can be subjected to a pressurized cleaning fluid or to pressurized air depending on the embodiment in order to be able to keep said see-through areas clean.

For the two see-through areas 40A and 40B, which are located close to the longitudinal center plane of the vehicle, roof module 12 has cleaning mechanisms 48A and 48B, respectively, which are provided with fluid nozzles 50A and 50B, respectively, which are disposed at an end of an extendable nozzle rod.

As FIG. 2 shows in a highly schematized manner, see-through areas 38A, 38B, 40A and 40B, which are made of plastic or glass and behind each of which one of environment sensors 34A, 34B, 36A and 36B is disposed, have a vibration sensor 52, which comprises a piezo element and which can detect the vibration behavior of the respective see-through area. Additionally, a vibration generator 58 can be provided, which can excite oscillations in the respective see-through area 38A, 38B, 40A or 40B and is connected to an evaluation and control unit 54 via a control line, which is illustrated by dashes.

Via a signal line, which is illustrated by dashes, vibration sensor 52 is connected to evaluation and control unit 54, which evaluates the measuring signals of vibration sensor 52 and by means of which foreign particles 56 which have accumulated on respective see-through area 38A, 38B, 40A or 40B can be classified and assessed. As a function of the change in vibration caused by foreign particles 56, respective fluid nozzle 44A, 44B, 50A or 50B can be activated by means of evaluation and control unit 54 via a control line, which is also illustrated by dashes, with the result that the fluid cone applied by the respective fluid nozzle removes foreign particles 56.

### REFERENCE SIGNS

10 vehicle roof
12 roof module
14 vehicle body shell
16 roof side beam
18 roof opening
20 lid element
22 roof frame
24 roof skin portion
26 roof skin portion
28 windshield
30A, B sensor module
32A, B sensor module
34A, B environment sensor
36A, B environment sensor
38A, B see-through area
40A, B see-through area
44A, B fluid nozzle
48A, B cleaning mechanism
50A, B fluid nozzle
52 vibration sensor
54 evaluation and control unit
56 foreign particles
58 vibration generator

1. A roof module of a motor vehicle, the roof module comprising:
a roof skin, which forms an outer visible surface of the roof module,
at least one sensor module comprising an environment sensor to detect a vehicle environment in an autonomous or semi-autonomous driving mode of the motor vehicle, and
a sensor cover forming a see-through area for the environment sensor, and
characterized by a detector for detecting foreign particles on the see-through area of the sensor cover.

2. The roof module according to claim 1, wherein the detector comprises a vibration sensor.

3. The roof module according to claim 1, wherein the detector comprises a vibration generator.

4. The roof module according to claim 2, further comprising an evaluation and control unit for evaluating a signal of the vibration sensor.

5. The roof module according to claim 1, characterized in that wherein the evaluation and control unit comprises means which classify detected foreign particles.

6. The roof module according to claim 1, characterized by further comprising a cleaning mechanism for the see-through area, the cleaning mechanism being configured to be activated as a function of an output signal of the detector.

7. The roof module according to claim 6, wherein the cleaning mechanism comprises a fluid nozzle.

8. The roof module according to claim 6, wherein the cleaning mechanism comprises a wiping assembly.

9. The roof module according to claim 1, characterized in that wherein the cleaning mechanism comprises an oscillation generator.

10. The roof module according to claim 1, wherein the sensor cover is part of a cover element which is part of the roof skin or which forms the roof skin and which extends between two lateral edges of the roof module.

11. The roof module according to claim 10, wherein multiple see-through areas for multiple environment sensors are formed on the cover element, and each see-through area is assigned a detector, which comprises a vibration sensor and a vibration generator, for detecting foreign particles on the respective see-through area and a cleaning mechanism, which works as a function of an output signal of the detector.

12. The roof module according to claim 1, further comprising a roof frame on which the at least one sensor module is disposed and which is covered by the roof skin.

13. A motor vehicle comprising a roof module according to claim 1.
